(19) United States
(12) Patent Application Publication
(10) Pub. No.: US 2015/0226613 A1
(43) Pub. Date: Aug. 13, 2015

(54) IMAGING DEVICE WITH SHUTTERLESS NON-UNIFORMITY CORRECTION

(71) Applicant: RAYHEON COMPANY, WALTHAM, MA (US)

(72) Inventors: Marc C. Bauer, Goleta, CA (US); Ross E. Williams, Santa Barbara, CA (US)

(73) Assignee: RAYTHEON COMPANY, WALTHAM, MA (US)

(21) Appl. No.: 14/175,023

(22) Filed: Feb. 7, 2014

(51) Int. Cl. G01J 5/52; G01J 5/20; G01J 5/06

(52) U.S. Cl. CPC G01J 5/52; G01J 5/061; G01J 5/20; G01J 2005/0077

(57) ABSTRACT

An imaging device including a focal plane array and capable of providing non-uniformity correction (NUC) without using a shutter outside the focal plane array. In one example, the imaging device includes a focal plane array that comprises an array of pixels arranged in rows and columns, the array of pixels corresponding to an imaging area of the focal plane array, the plurality of pixels including a first plurality of imaging pixels and a second plurality of reference pixels. The first plurality of imaging pixels are configured to receive incident electromagnetic radiation from a viewed scene and provide image signals, and the second plurality of reference pixels are shielded from receiving the incident electromagnetic radiation and are configured to produce non-uniformity correction signals.

### BACKGROUND

Uncooled microbolometer arrays (also called focal plane arrays, or FPAs) are used in a variety of thermal (infrared) imaging applications. As the microbolometers have been made more sensitive to incoming electromagnetic radiation, they have also become more sensitive to effects of self-heating, which causes a change in the intensity output from the pixels of the array. Changes in intensity tend to be non-uniform across the many pixels of the array, causing different pixels receiving the same input radiation to produce different outputs, and contributing to noise in the image.

One approach to non-uniformity correction (NUC) in uncooled microbolometer arrays is to periodically shutter the FPA, or the lens that focuses incident electromagnetic radiation onto the FPA, for a few seconds to allow for a non-uniformity correction of the image to be calculated. Some conventional uncooled microbolometer designs use video reference pixels (VRP) on the sides of the rows of the FPA to compensate for non-uniformity by continuously normalizing the row to row non-uniformity. However, non-uniformities also occur in the columns and high energy image locations, requiring the image to be corrected using a shutter.

Another method of non-uniformity correction is known as scene-based NUC, requires the viewed scene to be changing, and may involve complex image processing.

### SUMMARY OF THE INVENTION

Aspects and embodiments are directed to methods for producing non-uniformity correction (NUC) without using a shutter outside the focal plane array (FPA). As discussed in more detail below, according to certain embodiments, designated reference pixels within the image area are used for the NUC calculations. Aspects and embodiments may provide numerous benefits, including removal of the need for a mechanical shutter, and avoidance of the loss of imaging time associated with the use of a shutter, as well as lower overall cost of a complete thermal imaging camera.

According to one embodiment, an imaging device comprises a focal plane array comprising an array of pixels arranged in rows and columns, the array of pixels corresponding to an imaging area of the focal plane array, the plurality of pixels including a first plurality of imaging pixels and a second plurality of reference pixels, wherein the first plurality of imaging pixels are configured to receive incident electromagnetic radiation from a viewed scene and provide image signals; and wherein the second plurality of reference pixels are shielded from receiving the incident electromagnetic radiation and are configured to produce non-uniformity correction signals.

The imaging device may further comprise optics configured to focus the incident electromagnetic radiation onto the imaging area of the focal plane array. In one example, the optics includes a lens having an f/#=1. The imaging device may further comprise a substrate, and the focal plane array may be disposed over the substrate. In one example, the substrate is a ceramic substrate. The imaging device may further comprise a thermocooler positioned between the substrate and the focal plane array. The imaging device may further comprise a reflective coating disposed over the second plurality of reference pixels, the reflective coating shielding the second plurality of reference pixels from receiving the incident electromagnetic radiation. In one example, the reflective coating includes a layer of gold. In one example, the layer of gold has a thickness in a range of approximately 2-300 nanometers. In another example, the reflective coating includes a layer of aluminum. In one example, the second plurality of reference pixels are arranged in a regular pattern over the array of pixels. In one example, the second plurality of reference pixels comprises between approximately 0.39% and 50% of the array of pixels. In another example, the second plurality of reference pixels comprises approximately 12.5% of the array of pixels. In another example, the second plurality of reference pixels includes at least one reference pixel in each row and column of the array of pixels. In another example, the focal plane array is a microbolometer array, and the incident electromagnetic radiation is infrared radiation.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a block diagram of a solid-state imaging device, according to aspects of the present invention;

FIG. 2 is block diagram of one example of a focal plane array having an arrangement of reference pixels according to aspects of the invention;

FIG. 3A is a block diagram of another example of a focal plane array having another arrangement of reference pixels according to aspects of the invention;

FIG. 3B is block diagram of another example of a focal plane array having another arrangement of reference pixels according to aspects of the invention;

FIG. 3C is a block diagram of another example of a focal plane array having another arrangement of reference pixels according to aspects of the invention; and

FIG. 4 is a block diagram illustrating in schematic cross-section one example of a focal plane array according to aspects of the invention.

### DETAILED DESCRIPTION

As discussed above, conventional uncooled microbolometer designs have always used a shutter to generate a single point offset non-uniformity correction (NUC). As the focal plane array (FPA) drifts in temperature, low frequency image artifacts appear making the image less usable. Furthermore, use of a shutter is undesirable in many applications. For example, a mechanical shutter may be noisy, making it unsuitable for use in applications where stealth is important. Additionally, the shutter is typically closed for a least a second, sometimes several seconds, rendering the imaging system “blind” and incapable of imaging the scene during this time. This may be particularly undesirable in applications and circumstances where continuous imaging is necessary and where losing the imaging capability for a second or more at a time may significantly negatively impact system performance (e.g., in target-tracking applications). As the shutter is a moving mechanical part, it may also be a point of failure in the system.

Aspects and embodiments are directed to apparatus and methods for shutterless NUC in microbolometer arrays or other FPAs. As discussed in more detail below, according to one embodiment, certain pixels within the imaging region of the array are designated as video reference pixels and applied with a coating that blocks incident electromagnetic radiation from being received. Accordingly, any output from these reference pixels is produced only by noise internal to the imaging system (e.g., thermal noise from self-heating of the pixels), not from any incident electromagnetic radiation, and may therefore be used to generate NUC signals. Unlike shutter-based solutions, embodiments of the devices and methods disclosed herein do not block or stop image collection during the correction. Additionally, embodiments disclosed herein do not require the viewed scene to be changing, as is the case for scene-based NUC. Furthermore, as discussed in more detail below, NUC correction may be applied on every frame, or with any spacing in time.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

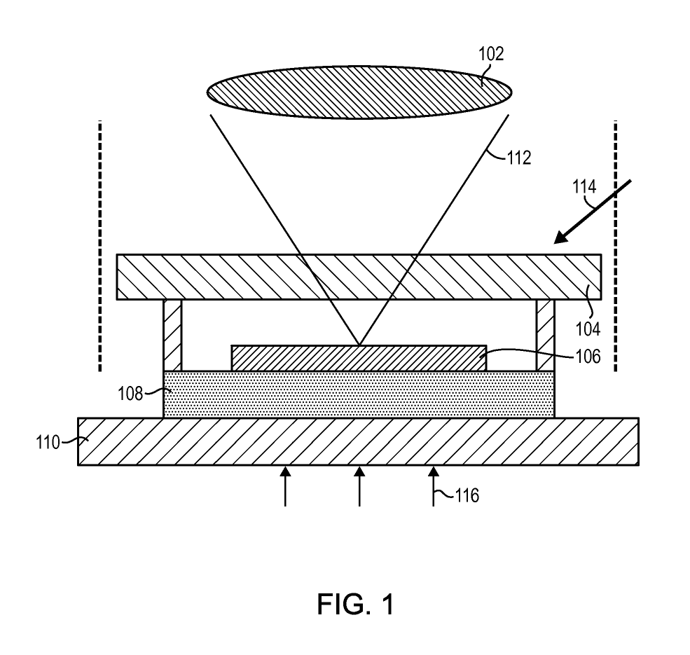

Referring to FIG. 1, there is illustrated a block diagram of one example of a solid-state imaging device 100, showing thermal paths in the device. The imaging device 100 includes a lens 102, window 104, an FPA 106, optionally a thermoelectric cooler (TEC) 108, and a base 110. The FPA 106 may include an n×m array of detectors positioned at a focal plane of the lens 102. In some implementations, the FPA 106 is an uncooled microbolometer array configured to receive and detect electromagnetic radiation in the micrometer (μm) wavelength region. The pixels of the FPA 106 may be configured to detect electromagnetic radiation in several wavelength regions at the same time, such as, for example, 3-5 μm and 8-14 μm regions. The lens 102 focuses electromagnetic radiation 112 from a viewed scene onto the FPA 106 via the window 104. In one example, the window 104 is composed of germanium due to its high index of refraction and dispersion. For uncooled microbolometer designs, it may be preferable that the lens 102 is very fast. Accordingly, in one example the lens 102 has an f/# (f-number) of approximately 1; however, in other examples, the lens may have a different f/#. In one example, the base 110 is a ceramic base; however, in other examples, other materials may be used for the base. Although the device 100 is illustrated in FIG. 1 with the TEC 108, the device 100 may instead be implemented without TEC 108.

The FPA 106 receives the electromagnetic radiation 112 from the viewed scene, and produces an image therefrom. However, as discussed above, one or more pixels of the FPA may also receive undesired thermal radiation from elsewhere, leading to noise in the image. For example, as shown in FIG. 1, the FPA 106 may receive thermal radiation 114 from outside of the optics or imaging area of the FPA. For example, the FPA typically includes read-out circuitry associated with the detectors, such as row and/or column amplifiers. These devices may heat up in operation, causing thermal radiation 114 that is received by the FPA 106. Additionally, the FPA 106 may receive thermal radiation 116 via the base 110. As discussed above, as the detectors are made more and more sensitive to allow for better thermal imaging performance, they also become more sensitive to noise, particularly noise cause by self-heating. The pixels may be super-sensitive to their own heat, in some designs measuring their own temperature 100 times better than they measure the incident electromagnetic radiation 112. For example, if the temperature of the FPA 106 rises only a single degree Celsius, this change in temperature may be measured by the pixels of the array and use up as much as 50% of the dynamic range of the FPA. Adding to this problem, which significantly impacts the signal-to-noise ratio in the image produced by the FPA 106, is the fact that not all pixels in the array receive the same thermal noise radiation (114, 116), heat up at the same rate, and/or measure their own temperatures to the same precision. Thus, there are non-uniformities in the photo-response of the pixels that are unrelated to the received incident electromagnetic radiation 112 from the viewed scene. Although attempts have been made to address the problems of self-heating, for example, by using the TEC 108, structures underneath the FPA 106 cannot remove the non-uniformities. Accordingly, as discussed above, conventionally a shutter has been the only mechanism by which NUC signals are produced and used to “balance” the image produced by the FPA 106.

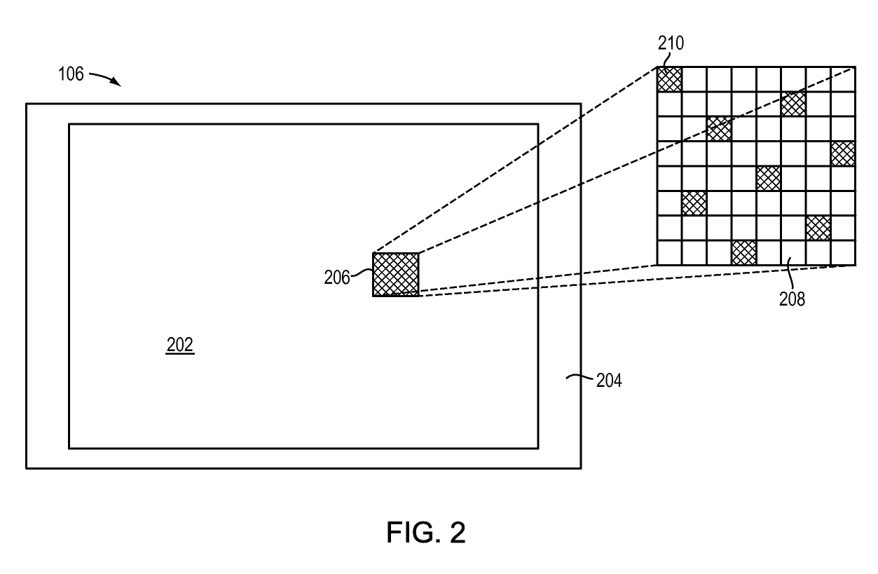

According to one embodiment, a method for NUC in the FPA 106 includes designating certain pixels within the imaging area of the FPA 106 as video reference pixels, and shielding these pixels from the incident electromagnetic radiation 112. Referring to FIG. 2, there is illustrated schematically one example of the FPA 106, showing an example of a distribution pattern of reference pixels. The FPA 106 includes an imaging area 202 surrounded by an edge area 204. As discussed above, row and/or column amplifiers, along with other read-out circuitry, may be disposed in the edge area 204. The imaging area 202 includes an array of pixels 208 arranged in rows and columns. This array structure is illustrated in the enlarged portion 206 of the imaging area 202 of the FPA 106. In the illustrated example, the portion 206, shown enlarged, corresponds to a sub-array of 8×8 pixels. As discussed above, certain pixels are designated as reference pixels 210. The reference pixels 210 are distributed throughout the imaging area 202. In the example illustrated in FIG. 2, the reference pixels 210 are arranged in offset diagonal rows; however, numerous other arrangements may be implemented. Additionally, the relative array density of the reference pixels 210 versus the imaging pixels 208 may be selected based on any one or more of several factors, including, for example, desired resolution in NUC, and ability to “lose” imaging pixels in the array (as discussed above, the reference pixels 210 are shielded from the incident electromagnetic radiation 112 and therefore cannot be used for imaging). For example, for an FPA 106 having an imaging area 202 of 640×480 pixels, the arrangement of reference pixels 210 illustrated in FIG. 2 may provide a reference pixel density of approximately 12.5%.

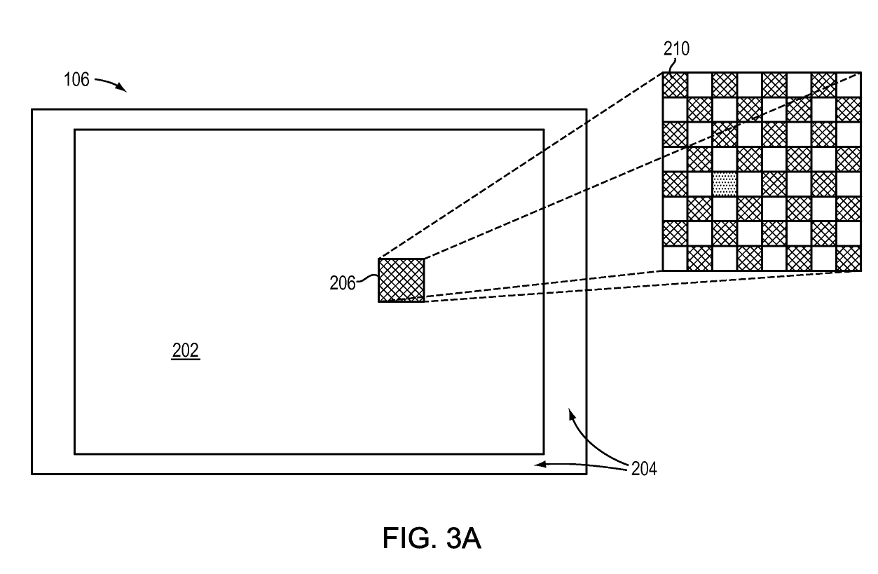

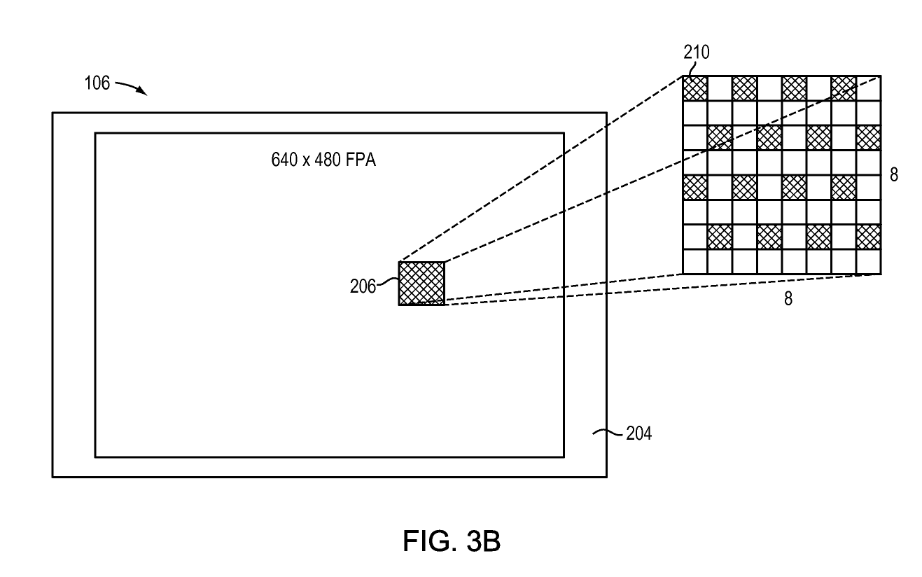

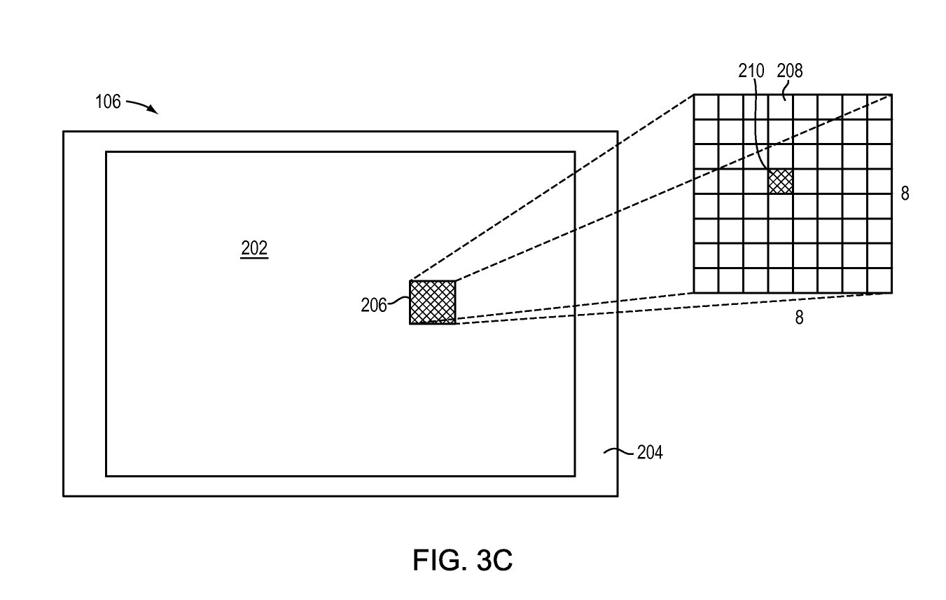

FIGS. 3A-C illustrate some other examples of patterns of reference pixels 210 that provide different array densities for the reference pixels. In each of FIGS. 3A-C, portion 206, shown enlarged to illustrate the pattern of reference pixels 210, corresponds to an 8×8 sub-array. In the example of FIG. 3A, 50% of the pixels are reference pixels, arranged in a checkerboard pattern. For the 640×480 example, this arrangement effectively reduces the imaging area 202 to a 320×240 array. In the example of FIG. 3B, approximately 25% of the pixels are reference pixels, arranged in a quasi-checkerboard pattern, and in the example of FIG. 3C, approximately 1.56% of the pixels are reference pixels. In certain examples, the size of the pixels in the array may be smaller, even significantly smaller, than the diffraction limited spot size of the incident electromagnetic radiation 112 received via the lens 102, and therefore pixels within the imaging area 202 may be used as reference pixels without significantly impacting the imaging performance of the device 100. For example, 12 μm pixels are smaller than the diffraction limited spot size of long-wave infrared (LWIR) radiation (in the wavelength range of approximately 8-12 μm). Neighboring pixels 208 may be used to generate the image, optionally using well-known “dead pixel” removal algorithms to “ignore” the reference pixels 210.

The arrangements of reference pixels 210 illustrated in FIGS. 2 and 3A-C are exemplary only, and not intended to be limiting. Those skilled in the art will recognize, given the benefit of this disclosure, that numerous arrangements or patterns of reference pixels may be implemented. According to one embodiment, the reference pixels 210 may be arranged in a regular or irregular pattern within the imaging area 202, provided that there is at least one reference pixel in each row and column of the array, as illustrated in FIG. 2, for example. In some examples, certain pixels in the edge area 204 may also be used as reference pixels. As discussed above, some prior designs have used pixels located in the edge area 204 as reference pixels for NUC; however, aspects and embodiments differ from such prior designs in that, whether or not pixels in the edge area 204 are used for NUC, reference pixels 210 are distributed within the imaging area 202 and used for NUC. By distributing the reference pixels 210 across the imaging area 202 of the FPA 106, firmware associated with the device 100 may be configured to remove the non uniformities continuously during imaging, thereby removing the need for a shutter.

As discussed above, the reference pixels 210 are shielded from the incident electromagnetic radiation 112, such that they measure only self-heating and other thermal noise and may therefore be used to perform NUC. In one embodiment, this shielding is implemented by coating the reference pixels 210 with a reflective coating, such that the incident electromagnetic radiation 112 is reflected from the reference pixels 210, and not absorbed and measured. In one example, the reference pixels 210 are coated with a layer of gold. Gold may be selected because it is highly reflective, namely, approximately 98% reflective, in the infrared spectral band, and also adheres well to the semiconductor materials used to form the FPA 106. In one example, the layer of gold used to coat the reference pixels 210 has a thickness in a range of approximately 2-300 nanometers. In another example, the reference pixels 210 may be coated with a layer of aluminum. Aluminum is approximately 90% reflective in the infrared spectral band.

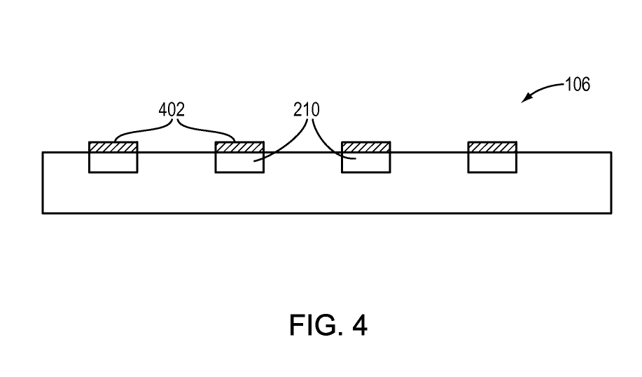

FIG. 4 illustrates, in schematic cross-section, one example of the FPA 106 including a coating layer 402 positioned over certain region of the FPA corresponding to the reference pixels 210. As discussed above, the coating layer 402 may include gold, aluminum, or another reflective metal or other reflective material. In particular, the material of the coating layer 402 may be highly reflective (e.g., 90% or above) to radiation in at least a portion of the infrared spectral band.

Thus, aspects and embodiments provide an imaging device, in particular a microbolometer array, with built-in, shutterless NUC. Reference pixels are distributed within the imaging area of a focal plane array, providing numerous sample points over the imaging plane that can be used for NUC. As discussed above the reference pixels are permanently shielded from receiving incident electromagnetic radiation via the imaging optics, for example, by using a highly reflective coating over the surface area of the reference pixels. In this manner, signals from the reference pixels may be used by image processing firmware and/or software associated with the focal plane array to provide NUC signals which can be used to adjust the image produced by the imaging pixels of the array to compensate for non-uniformities in the photo-response of the array, for example, due to self-heating or other thermal noise. Unlike conventional scene-based NUC, which typically only addresses high-frequency content, aspects and embodiments of the present invention may provide the ability to remove low-frequency noise structures from the images produced by the array. Furthermore, NUC may be performed continuously during the imaging operation of the array, without requiring image collection to be stopped during the correction, as is the case in conventional shutter-based systems.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An imaging device comprising:
a focal plane array comprising an array of pixels arranged in rows and columns, the array of pixels corresponding to an imaging area of the focal plane array, the plurality of pixels including a first plurality of imaging pixels and a second plurality of reference pixels;
wherein the first plurality of imaging pixels are configured to receive incident electromagnetic radiation from a viewed scene and provide image signals; and
wherein the second plurality of reference pixels are shielded from receiving the incident electromagnetic radiation and are configured to produce non-uniformity correction signals.

2. The imaging device of claim 1, further comprising optics configured to focus the incident electromagnetic radiation onto the imaging area of the focal plane array.

3. The imaging device of claim 2, wherein the optics includes a lens having an f/#=1.

4. The imaging device of claim 1, further comprising a substrate, wherein the focal plane array is disposed over the substrate.

5. The imaging device of claim 4, wherein the substrate is a ceramic substrate.

6. The imaging device of claim 4, further comprising a thermocooler positioned between the substrate and the focal plane array.

7. The imaging device of claim 1, further comprising a reflective coating disposed over the second plurality of reference pixels, the reflective coating shielding the second plurality of reference pixels from receiving the incident electromagnetic radiation.

8. The imaging device of claim 7, wherein the reflective coating includes a layer of gold.

9. The imaging device of claim 8, wherein the layer of gold has a thickness in a range of approximately 2-300 nanometers.

10. The imaging device of claim 7, wherein the reflective coating includes a layer of aluminum.

11. The imaging device of claim 1, wherein the second plurality of reference pixels are arranged in a regular pattern over the array of pixels.

12. The imaging device of claim 11, wherein the second plurality of reference pixels comprises between approximately 0.39% and 50% of the array of pixels.

13. The imaging device of claim 12, wherein the second plurality of reference pixels comprises approximately 12.5% of the array of pixels.

14. The imaging device of claim 11, wherein the second plurality of reference pixels includes at least one reference pixel in each row and column of the array of pixels.

15. The imaging device of claim 1, wherein the focal plane array is a microbolometer array, and wherein the incident electromagnetic radiation is infrared radiation.
